(19) United States
(12) Patent Application Publication
(10) Pub. No.: US 2026/0057870 A1
(43) Pub. Date: Feb. 26, 2026

(54) RECONFIGURABLE ACOUSTIC NOISE SUPPRESSION METASURFACE USING INTEGRATED HEATERS

(71) Applicant: Dell Products L.P., Round Rock, TX (US)

(72) Inventors: Kan Wang, Ottawa (CA); Tejinder Singh, Manotick (CA); Navjot Kaur Khaira, Manotick (CA)

(21) Appl. No.: 18/811,241

(22) Filed: Aug. 21, 2024

(51) Int. Cl. G10K 11/172; G10K 11/162

(52) U.S. Cl. CPC G10K 11/172; G10K 11/162

(57) ABSTRACT

The technology described herein is directed towards a metasurface arranged with unit cells for narrowband sound absorption, in which the unit cells are based on Helmholtz resonators that can have their resonant frequencies adjusted via heaters that change the internal temperatures of the resonators. A sound absorbing unit-cell is designed and constructed based on a general resonance frequency, and includes a neck portion and air chamber dimensioned to resonate close to the desired resonance frequency and thereby inverse phase cancel corresponding narrowband frequencies of incoming sound waves. A heater, controlled by a controller, facilitates changing of the air temperature in the unit cells to adjust the resonant frequencies thereof, to cancel acoustic waves of different frequencies corresponding to noise, which can change over time. The unit cells can be distributed as part of a metasurface, which can be positioned proximate to a noise source to phase cancel the noise.

### BACKGROUND

Acoustic absorbers are specialized materials or structures designed to mitigate the effects of sound reflections, echoes, and reverberations in various environments. These absorbers function by capturing sound waves and converting their energy into heat, effectively reducing the intensity of the sound waves and preventing them from bouncing off surfaces and causing unwanted sound reflections. They are typically engineered using porous materials with intricate structures that allow sound waves to penetrate deep into the material, where the acoustic energy is dissipated as thermal energy through friction and air resistance.

Existing acoustic absorbers come in various forms, including foam panels, fabric-wrapped panels, diffusers, bass traps, and more. One of the problems with existing acoustic absorbers is that they are not desirable in certain heat-sensitive environments. For example, servers generate a lot of heat and thus are designed with fans to cool dissipate the heat; however, fans can generate a lot of annoying noise. Using existing acoustic absorbers to absorb server noise reduces the noise, but can significantly reduce dissipation of the heat generated by servers, which can result in high heat levels that can reduce server performance and possibly cause a server to shut down to avoid damage from overheating.

### BRIEF DESCRIPTION OF THE DRAWINGS

The technology described herein is illustrated by way of example and not limited in the accompanying figures in which like reference numerals indicate similar elements and in which:

FIG. 1A is a block diagram showing an example system for implementing a metasurface with heaters in resonating unit cells for noise cancellation by phase canceling a narrowband frequency in acoustic waves, in accordance with various example embodiments and implementations of the subject disclosure.

FIG. 1B is a representation of an example metasurface deployed for noise cancellation, including a resonator with a heaters for varying the resonance frequency, in accordance with various example embodiments and implementations of the subject disclosure.

FIG. 2A is a two-dimensional side view representation of example unit-cells, including one enlarged unit cell showing various dimensions that determine, in part, the unit cell's resonance frequency, in accordance with various example embodiments and implementations of the subject disclosure.

FIG. 2B is a graphical representation of resulting absorption coefficient values of the unit-cell(s) of FIG. 2A over a range of frequencies, including a very high absorption coefficient value at the designed frequency 1310 Hz, in accordance with various example embodiments and implementations of the subject disclosure.

FIG. 3 is a side view representation of an example noise canceling Helmholtz resonator that includes a single heater for varying the resonance frequency by changing the air temperature (via air density change) in the resonator's chamber, in accordance with various example embodiments and implementations of the subject disclosure.

FIG. 4A is a side view representation of an example noise canceling Helmholtz resonator that includes multiple heaters for varying the resonance frequency by changing the air temperature in the resonator's chamber, in accordance with various example embodiments and implementations of the subject disclosure.

FIG. 4B is a top view representation of an example noise canceling Helmholtz resonator that includes a wraparound penannular ring-shaped heating element and a bottom heating element for varying the resonance frequency by changing the air temperature (air density) in the resonator's chamber, in accordance with various example embodiments and implementations of the subject disclosure

FIG. 5 is a side view representation of example noise canceling Helmholtz resonators with heaters powered by a shared power source as controlled by a controller, in accordance with various example embodiments and implementations of the subject disclosure.

FIG. 6 is a side view representation of an example noise canceling Helmholtz resonator that includes heaters for varying the resonance frequency by changing air temperature in the resonator's chamber based on sensor feedback to a controller, in accordance with various example embodiments and implementations of the subject disclosure.

FIG. 7 is a three-dimensional representation of an example sound absorbing metasurface showing an enlarged view of an example unit cell with air temperature changing capabilities, in accordance with various example embodiments and implementations of the subject disclosure.

FIG. 8 is a representation of an example portion of a sound absorbing metasurface showing an enlarged view of two of a metasurface's adjacent, variable air temperature unit cells positioned to phase cancel a narrowband frequency within incoming acoustic waves from a server, in accordance with various example embodiments and implementations of the subject disclosure.

FIG. 9 is a representation of an example portion of a sound absorbing metasurface showing an enlarged view of two of a metasurface's adjacent, variable air temperature unit cells positioned to phase cancel a narrowband frequency within incoming acoustic waves from a rack of servers, in accordance with various example embodiments and implementations of the subject disclosure.

FIG. 10 is a three-dimensional, perspective representation of an example sound absorbing metasurface composed of unit cells for wrapping around a rack of servers to reduce noise emanating from the servers, in accordance with various example embodiments and implementations of the subject disclosure.

FIG. 11 is a flow diagram showing example operations related to controlling a heater to adjust air temperature within a Helmholtz resonator unit cell, to resonate the Helmholtz resonator unit cell to cancel acoustic wave noise, in accordance with various example embodiments and implementations of the subject disclosure.

### DETAILED DESCRIPTION

Various embodiments and implementations of the technology described herein are generally directed towards a sound absorbing device based on inverted phase cancellation, and more particularly towards Helmholtz resonators with heaters controlled to vary temperatures within the resonators and thus vary the resonance frequency of the resonators. In one implementation, one or more flexible or rigid thin resistor-based heaters are positioned within or substantially close to a Helmholtz resonator, and controlled using a controller/power source to change the temperature. The acoustic pressure in the Helmholtz resonators is tuned by changing the air density inside the cavity by heating the resonator, e.g., its surface and the air within. A resulting resonance shift can be achieved, that is, the resulting resonance shift changes the resonance frequency of the resonator.

The technology described herein facilitates the design and implementation of such unit cells into metasurfaces that can be configured and positioned to efficiently absorb and dissipate sound waves of a specific frequency. Significantly, the use of metasurfaces as described herein do not increase the heat levels of computing devices substantially compared to existing technologies for sound absorption that do not facilitate ventilation/do not dissipate the heat very well. The specific frequency can be of any frequency/narrowband frequency range over a broad range of audible frequencies, or even subsonic (below 20 Hz)/supersonic frequencies (up to about 20,000 Hz).

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state.

Further, it is to be understood that the present disclosure will be described in terms of a given illustrative architecture; however, other architectures, structures, substrate materials and process features, and steps can be varied within the scope of the present disclosure.

It will also be understood that when an element such as a layer, region or substrate is referred to as being “on” or “over” another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

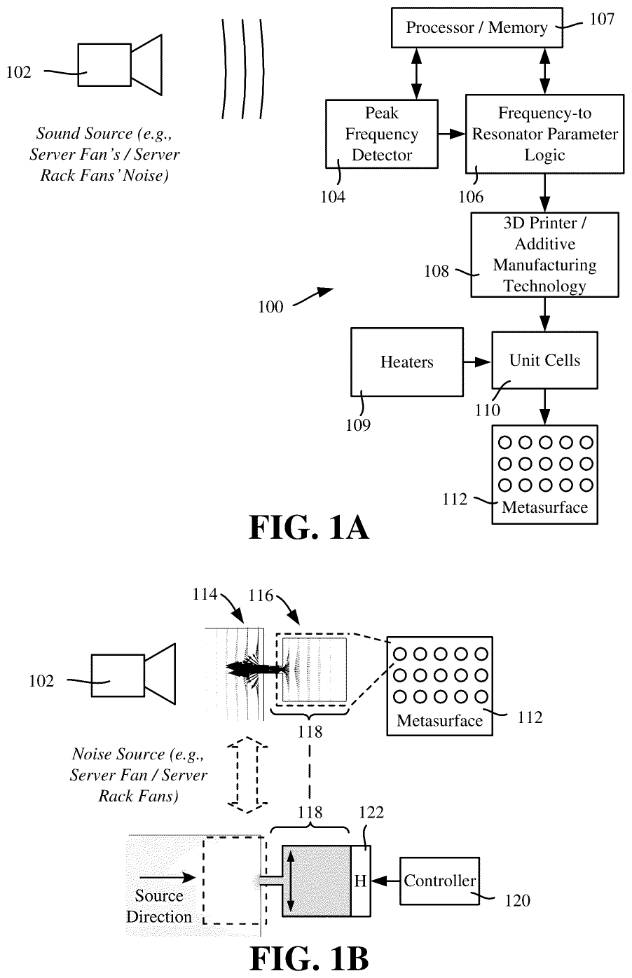

FIG. 1A shows a generalized block diagram of an example system 100 including a sound source 102 such as server fan/fans of a rack of servers that generate undesirable noise including at a frequency that is to be absorbed based on the technology described herein. A frequency measurement tool can be used as a peak frequency detector 104 or the like to determine which approximate narrowband frequency to cancel as described herein. As will be seen, the frequency itself is absorbed extremely efficiently by the technology described herein, with a narrow band of nearby frequencies also reduced to a lesser, but still desirable, extent.

Once the general frequency to cancel is determined, frequency-to resonator parameter logic 106 can be used to determine the parameters of unit cells that can inverse phase cancel that frequency. The parts of the unit cell can be constructed with 3D printer/additive manufacturing technology 108. The heaters, described herein, can be 3D printed with respect to their thin resistive elements, or can be separately fabricated (block 109), and, for example, can be incorporated into the unit cell, or positioned at a location that can change airflow in the unit cell. As a more particular example, consider a Helmholtz resonator cavity (e.g., the chamber portion) that includes a heater. The heater can be controlled to change the air temperature within the unit cell's chamber, thereby establishing the resonant frequency of the Helmholtz resonator.

The unit cells are based on the principles of Helmholtz resonators, which are acoustic cavities with a small neck port or opening that are highly effective at absorbing specific frequencies via resonance. For example, the resonant frequency (f_{resonance}) of a classical Helmholtz resonator with respect to frequencies in the audible range is determined by:

$${f}_{resonance} = \frac{c}{2 π} \sqrt{\frac{S}{{L}_{p} V}}$$

where c is the speed of sound, S is the neck port cross-sectional area, Lₚ=L_{neck}+1.7r_{neck} (for a cylindrical neck port) and V is the unit cell's cavity chamber's volume.

The unit cells, each represented as a small circle in FIGS. 1A and 1B, are incorporated into a metasurface 112, which can then be positioned to cancel the noise source at the determined frequency. In one implementation, the metasurface 112 contains an array of the unit cell resonator units arranged in a two-dimensional pattern. For absorbing a server's fan noise, for example, the metasurface 112 can be positioned proximate to the server's location, or even wrapped around at least part of the server's housing. The same metasurface noise-cancellation concept can be extended to a rack of servers via appropriately-sized (e.g., larger) and/or more metasurfaces.

As generally represented in FIG. 1B, when incident sound waves (block 114) interact with the metasurface 112, the variable Helmholtz resonators within the array selectively absorb the corresponding frequencies via inverse phase cancellation (represented by vectors in blocks 114 and 116). As sound waves enter the resonators (e.g., the resonator 118) through the neck port, the sound waves create pressure fluctuations within the cavities. By engineering the geometrical parameters of the cavity/air chamber, and then adjusting the cavity airflow as needed (via a controller and heater 122) as described herein, the resulting resonance frequency of the unit cell creates a π phase shift reflected wave with respect to the incident wave as shown in FIG. 1B, where the two sets of waves with opposite phase cancel, effectively absorbing the frequency. This is highlighted via the air velocity vector plot showing the direction of the reflected wave with π phase shift in the upper portion of FIG. 1B. In addition, these pressure fluctuations also cause the air inside the cavities to oscillate, effectively converting acoustic energy into kinetic energy. This kinetic energy is then dissipated as heat through viscous losses in the narrow neck of the resonators, however the heat dissipation is appreciably better relative to traditional sound absorbers and does not significantly affect thermal performance of a server.

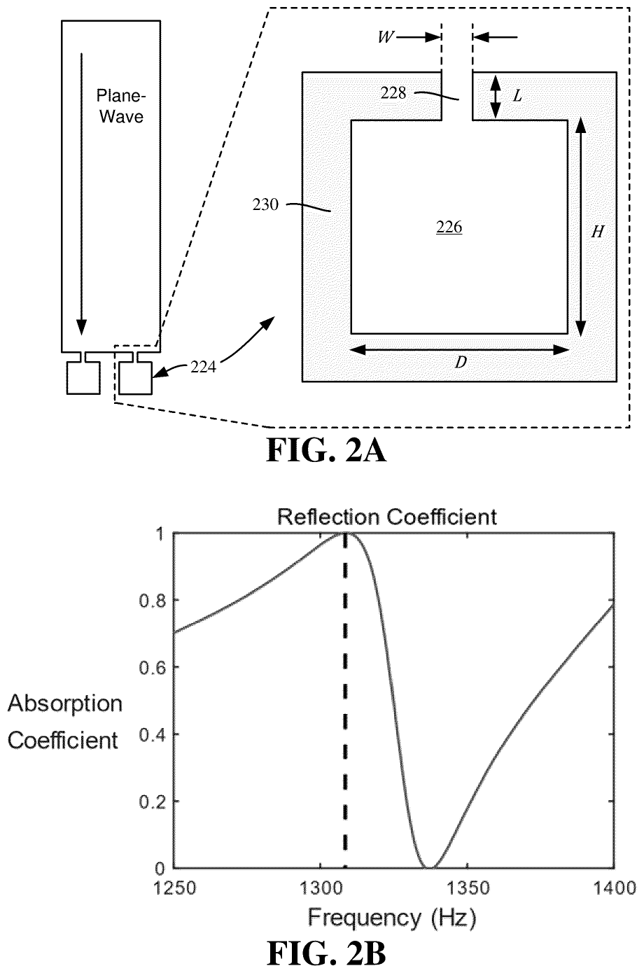

As generally represented in FIG. 2A, each unit cell 224 comprises a cavity, or air chamber 226, often with a neck port 228 that exposes the air chamber to the air/incoming sound waves, with dimensions engineered to target a particular frequency or a narrowband range of frequencies of interest. The dimensions of the air chamber 226 and neck port 228 are designed based on generally desired narrow band of acoustic frequencies to cancel, allowing the unit cells of the metasurface 112 (FIG. 1) to resonate when exposed to sound waves of those frequencies. When constructed, the air chamber 226 and neck port 228, which are hollow to contain air, and have one or more variable dimensions as described herein, are enclosed in a supporting structure 230 through which the neck port 228 extends to couple the chamber to the air propagating the sound wave.

FIG. 2A illustrates the unit cell's dimensions, which are “variable” during initial design before fabrication, and then once constructed and deployed, are controllably variable via heater adjustment (not explicitly shown in FIG. 2A) as described herein. The dimensions include the chamber height (H), and in the example of a cylindrical air chamber, the chamber's diameter (D) which is twice the radius, such that a cylindrical air chamber's volume is:

$$V = {( π \times \frac{1}{2} D )}^{2} \times H .$$

The neck port, which is also a cylindrical tube in this example, has an area of

$${( π \times \frac{1}{2} W )}^{2}$$

and a length of L. The unit cell is not limited to cylindrical air chambers or cylindrical necks, but can be of any suitable shape that facilitates resonating at the desired frequency in a manner that phase cancels the incoming sound wave of that frequency.

The result is highly efficient sound absorption at specific frequencies as shown in FIG. 2B, which in this example is around 1310 Hz, making this metasurface particularly useful for targeted noise reduction in environments where controlling specific frequencies is beneficial, such as in architectural acoustics, automotive design, and industrial settings. The dimensions are deep subwavelength values relative to the subwavelength of the incoming wave. For example, one metasurface implementation was designed to inverse phase cancel an incoming frequency 1310 Hz, with selected unit-cell dimensions of D=18 mm, H=16 mm, L=6 mm, W=3.2 mm. The resulting absorption coefficient of the designed unit-cell achieved near-perfect (greater than 98 percent absorption at the designed frequency 1310 Hz), as shown in FIG. 2B. As can be seen from this example, the structure is deeply sub-wavelength; the wavelength/at 1310 Hz in air is 260 mm, which is controlled by unit-cell with thickness of 22 mm. As can be seen, the above-selected dimensions of D, H, L and W for 1310 hertz (λ=260 m) in air range from about λ/14 to λ/81 (or λ/13 if based on the thickness of 22 mm). Note that while the curve of FIG. 2B shows about seventy percent absorption effectiveness around 1250 Hz increasing to the peak absorption at the desired frequency 1310 Hz, the curve can be flattened more around the designed frequency to an extent, e.g., by slightly tweaking the dimensions of some of the unit cells.

The designed unit-cell only needs air and its surrounding acoustic hard boundaries. This is different from other approaches using porous and fibrous materials and gradient index materials. At this scale the unit-cell acts almost like a point towards the wave, so this design is not straightforward. However, the materials and the compact design in mm-scale/deeply sub-wavelength facilitate fabricating the unit cell as a thin, light-weight, and cost effective absorber with 3D printing technology.

With respect to using temperature as a variable to reconfigure the resonance frequency of the structure, the speed of sound in a specific medium can be used to achieve reconfiguration. As shown in the below equation, the speed of sound is changed by varying the medium temperature, which enables the use of electrically controlled heating elements in the unit-cell:

$${c}_{ideal} = \sqrt{γ \cdot \frac{P}{ρ}} = \sqrt{\frac{γ \cdot R \cdot T}{M}} = \sqrt{\frac{γ \cdot k \cdot T}{m}}$$

where c is the speed of sound, P is the pressure, ρ is the density, γ is the specific heat ratio, R is the gas constant, M is the molar mass, k is the Boltzmann constant and m is the mass.

The relationship between temperature of the medium and the speed of sound in the medium. Substituting this equation into the above resonance frequency equation yields the relationship utilized herein. Using a heating mechanism as described herein basically manipulates the speed term c.

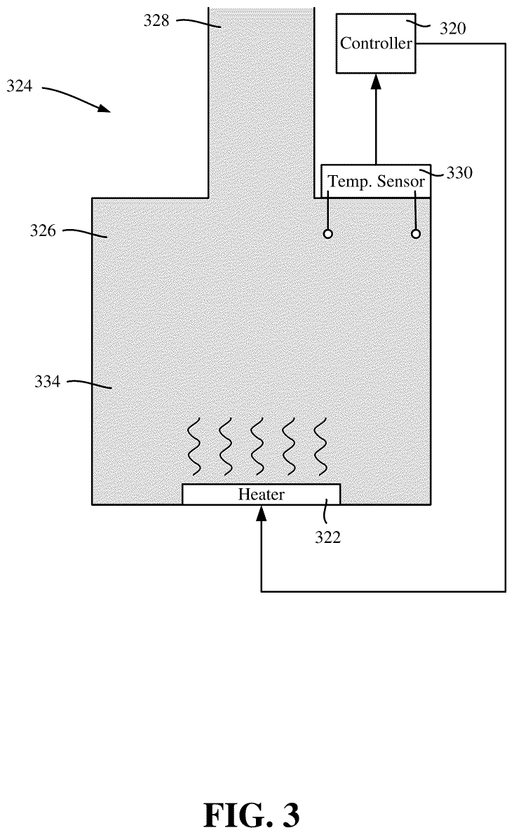

FIG. 3 shows the concept of an example Helmholtz resonator 324 with a default resonance frequency determined by dimensions of a chamber 326 and a neck port 328, and in which variable resonance is based on a heater 322, e.g., a thin resistive thin heating element. The temperature of the resonator 324 is controlled by a controller 320, e.g., based on temperature data sensed by a temperature (temp.) sensor 330. Note that the controller 320 can be coupled to control a power source (not explicitly shown in FIG. 3) to heat the heater 322, if, for example, the controller 320 is a small microcontroller that does not output sufficient power to heat the heater 322. Further note that such a heater can be positioned below the chamber rather than inside the chamber, although additional heat may be needed to transfer the heat into the chamber through the structure that supports the resonator 324.

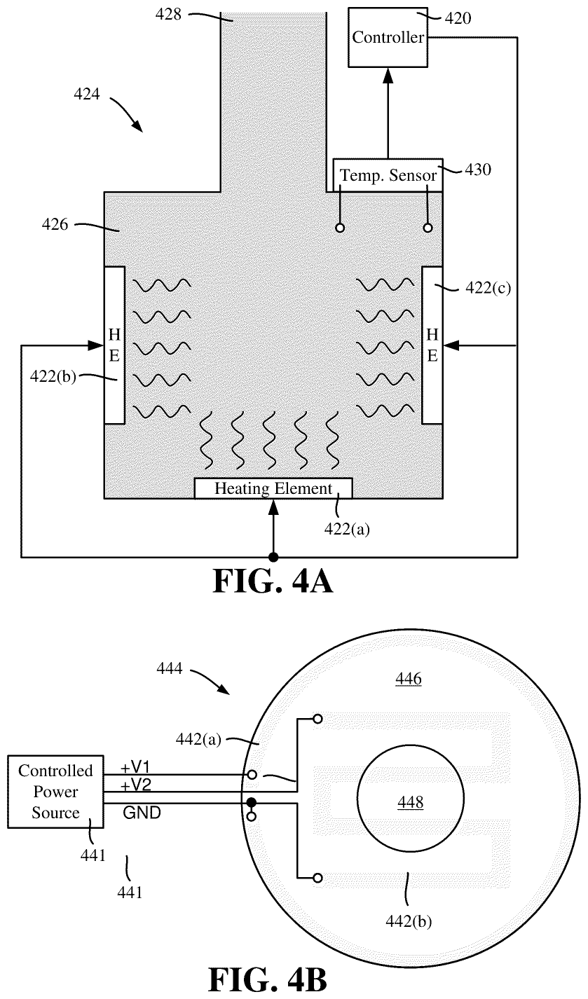

As shown in FIG. 4A, a heater (collectively 422) can be composed of separate heating elements (HE) 422(a)-422(c). Note that in the example of FIG. 4A, components similar to those labeled 3xx in FIG. 3 are labeled 4xx in FIG. 4, and are not described again for purposes of brevity.

FIG. 4B shows a top view of a resonator 444 in which two heating elements 442(a) and 442(b) are within (or proximate to) the resonator 444. One of the heating elements 442(a) wraps around most of the interior of the chamber 446, for example, which may help to distribute the heat more evenly in the chamber; (note that the chamber diameter can be designed with the thickness of the wraparound heating element 442(a) included). The heating element thus can be a penannular ring with a gap such that voltage can be applied across the gap. The other heating element 442(b) is shown as a floor-based heating element; it is feasible to have both heating elements 442(a) and 442(b) share the same positive voltage if designed appropriately. It is also feasible to have the wraparound heating element 442(a) be the only heater, or for a wraparound or other heating element to be in the neck port.

In this example, a controlled power source 441 is shown. Note that the power source 441 only needs to be used if a change is needed, e.g., it is feasible to design a metasurface with unit cell heaters but not heat them unless reconfiguration is needed, whereby the controller and/or power source can be added at that time.

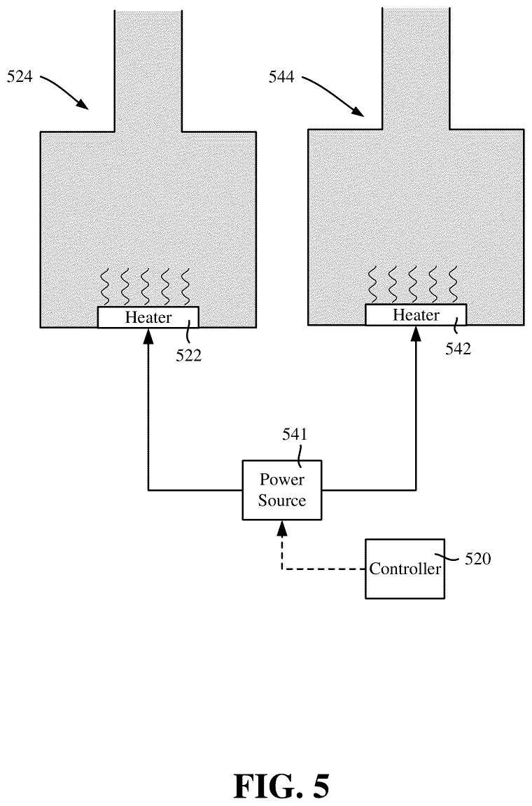

FIG. 5 shows the concept of two example Helmholtz resonators 524 and 544 that share the same controlled power source 541 for heating their heaters 522 and 542, respectively. Note that in the event a power source is needed for reconfiguration, a controller 520 (and temperature sensor per resonator, for example, not explicitly shown in FIG. 5) can be connected thereto as needed, and disconnected until adjustment to the power source 541 is again needed.

By way of an example usage scenario, consider a metasurface of such unit cells configured to noise cancel the fan noise emanating from a server. The Helmholtz resonators' resonant frequency can be adjusted as described herein to significantly cancel the noise. Later, consider that the server fan changes its frequency as the server heats up/cools down, or that the server is replaced with a different server having a different fan noise frequency. Adjusting the heater operates to cancel the different frequency instead.

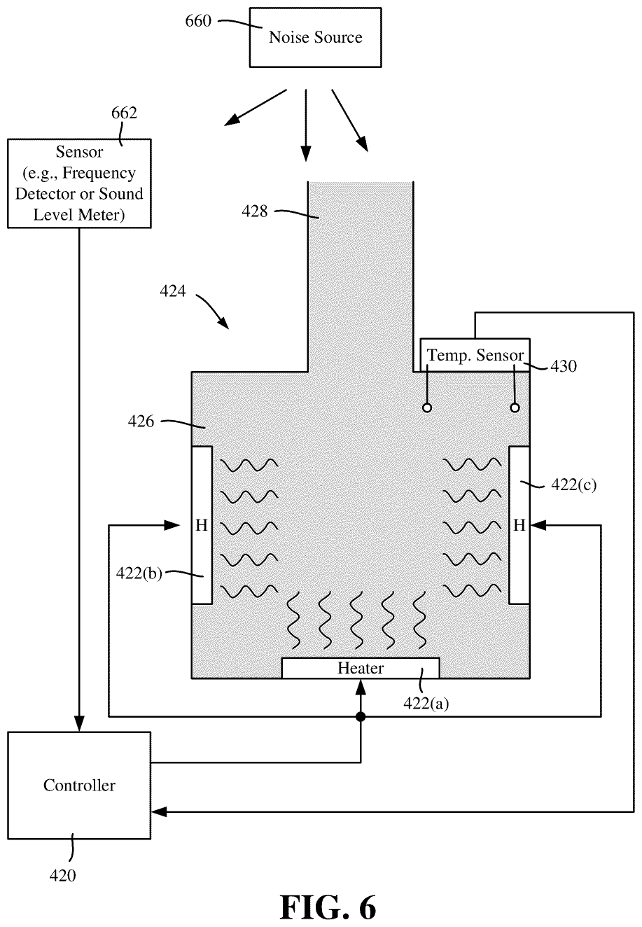

FIG. 6 shows the concept of feedback-based adjustment for noise cancellation, using the variable temperature resonator 424 of FIG. 4A as an example. In general, a noise source 660 such as one or more server fans outputs noise that can be sensed by a sensor 662. For example, a frequency sensor can pick up the main frequency peak of the noise, and communicate this information to the controller 420. The controller can then calculate (or look up/interpolate from previously determined data) the actuator voltage needed to change the temperature to cancel that frequency, and adjust the heating elements 422(a)-422(c) accordingly; the temperature sensor 430 can be used in conjunction with obtaining a more precise cavity temperature. Another alternative is to sense the noise level, e.g., at some appropriate location or locations, and adjust the heating elements 422(a)-422(c) until the lowest amount of noise level results. As the frequency of the acoustic wave (noise) changes, the heaters can be adjusted to cancel the changed frequency, which can be a reasonably rapid adjustment.

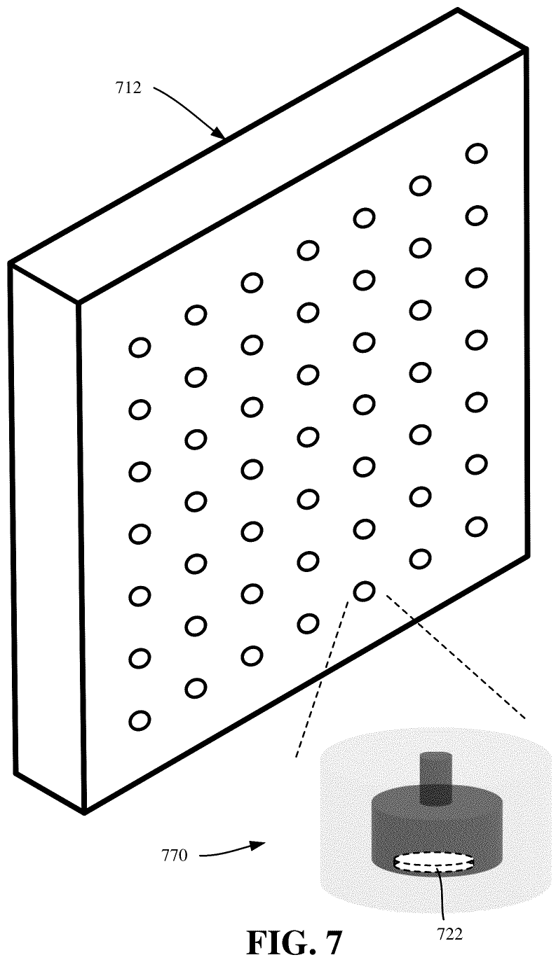

Some or all of the sound absorbing unit cells can be fabricated using 3D printing technology with the features of material simplicity and deeply sub-wavelength compact design. An illustration of an example metasurface 712 with an arrayed distribution of variable volume unit-cells (one of which labeled 770 with heater 722 is enlarged) is shown in FIG. 7.

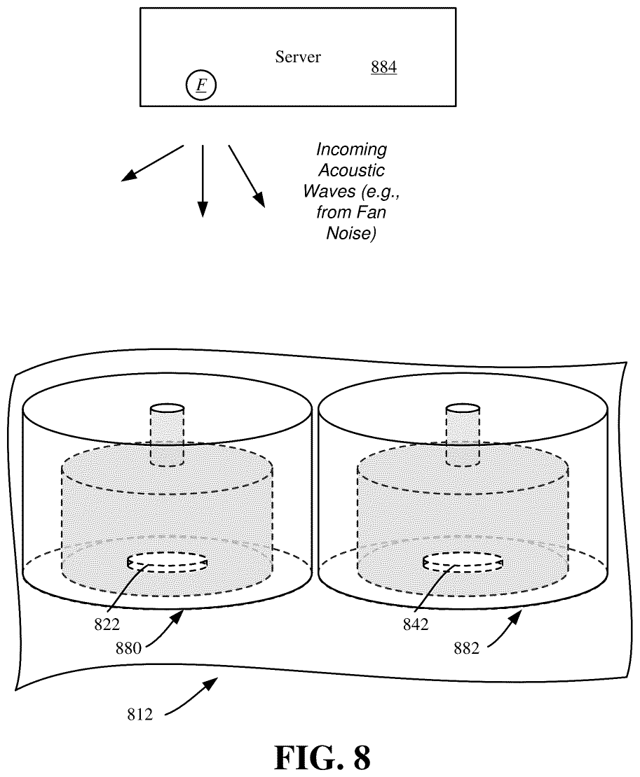

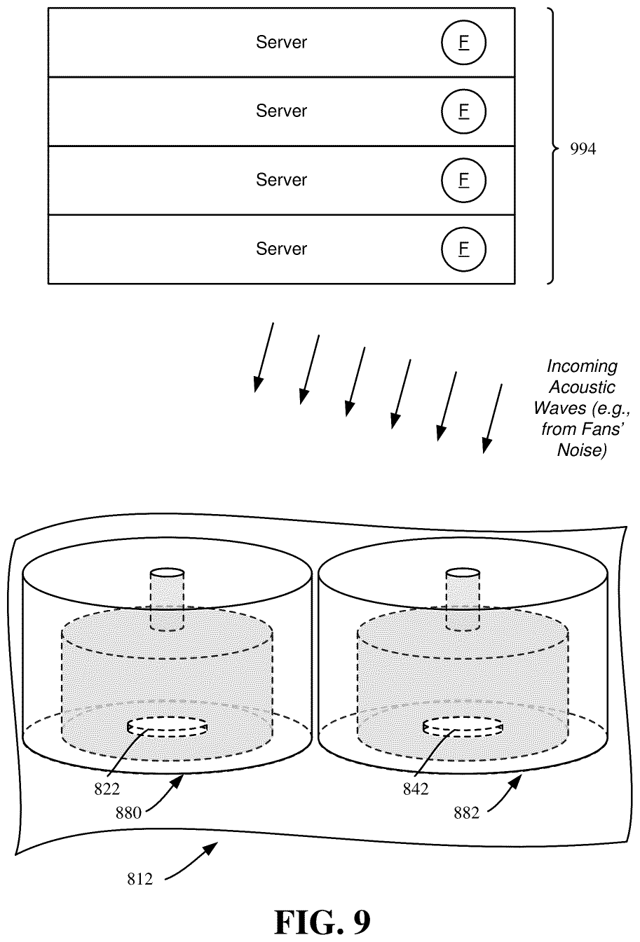

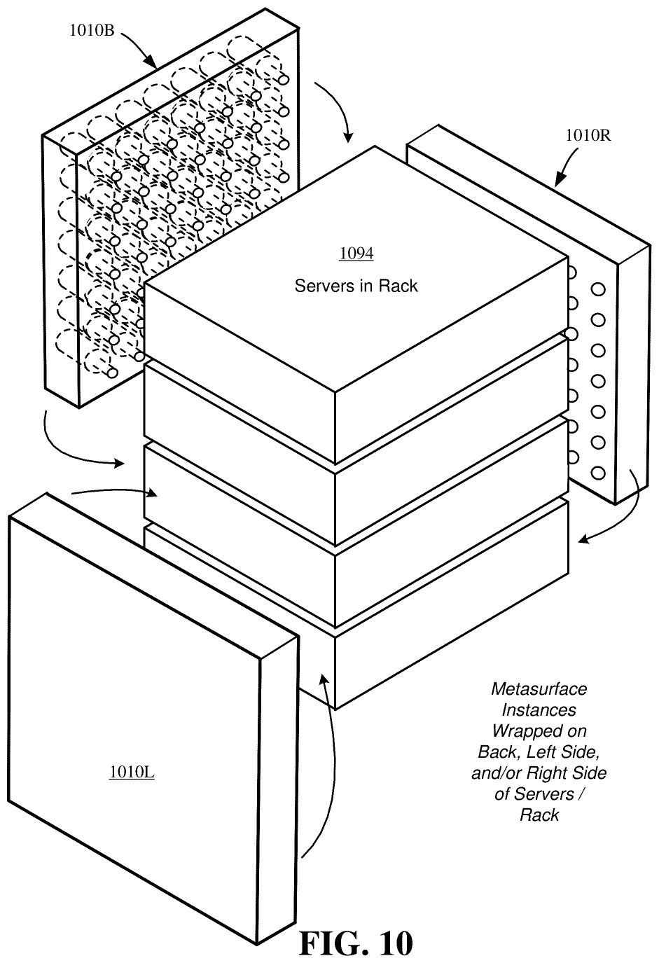

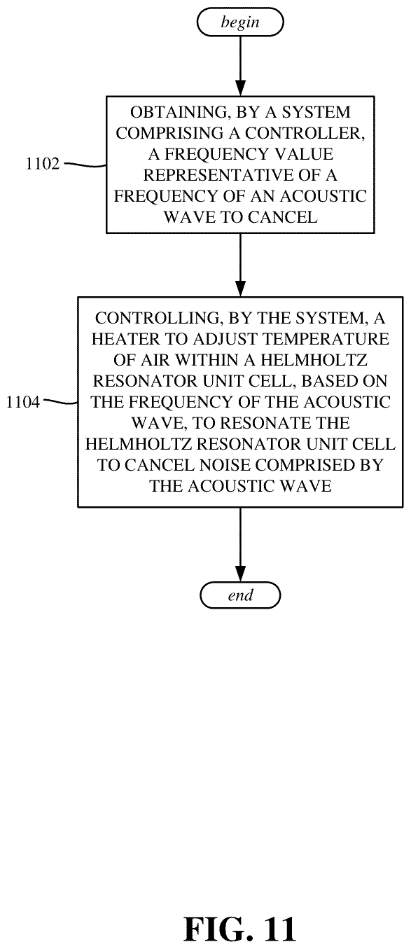

FIG. 8 depicts an example usage scenario, in which a portion of a metasurface 812 is shown with two enlarged variable temperature type unit cells 880 and 882 (with heaters 822 and 842, respectively) positioned proximate a server 884 to cancel noise emanating from the server's fan F. Although not explicitly shown herein, a metasurface or multiple metasurfaces as described herein can be positioned as a noise canceling device proximate a server (FIG. 8) or rack of servers 994 (FIG. 9), and/or wrapped around at least part of a server or rack of servers 1094 (metasurfaces 1010B, 1010L and 1010R) as depicted in FIG. 10.

One or more aspects can be embodied in a system, such as described and represented in the drawing figures herein. The system can include a unit cell of a metasurface configured for sound absorption within a narrowband frequency range, the unit cell can include an air cavity within a support; the air cavity can include a chamber and a neck port. The system further can include a heater that heats air in the air cavity to determine a resonant frequency of the unit cell, to resonate the unit cell at the resonant frequency to phase cancel the incoming acoustic wave, responsive to being exposed to the incoming acoustic wave.

The heater can include a resistive heating element that increases in temperature based on a controlled amount of energy applied to the resistive heating element.

The heater can include at least one heating element positioned proximate to a floor of the chamber.

The heater can include at least one heating element positioned proximate to a side of the chamber.

The heater can include at least one heating element positioned proximate to a floor of the chamber, and at least one heating element positioned proximate to a side of the chamber.

At least part of the heater can be within the air cavity.

The system further can include a sensor, and a controller coupled to the heater; the controller can selectively apply energy to the heater to heat the air in the air cavity based on data sensed by the sensor. The sensor can include a temperature sensor that senses air temperature data of the air within the air cavity as at least part of the data sensed by the sensor. The sensor can include a noise sensor that senses frequency data associated with a frequency of the incoming acoustic wave as at least part of the data sensed by the sensor.

The unit cell can be a first unit cell having first air in a first air cavity, and further comprising a second unit cell having second air in a second air cavity; the heater can include a shared heating device that heats the first air in the first air cavity, and the second air in the second air cavity.

The unit cell can be incorporated into a metasurface, which can include an array of unit cells, the metasurface can be positioned proximate a server, and wherein the incoming acoustic wave at the unit cell can result from operation of a cooling fan of the server, or the metasurface can be positioned proximate to a rack of servers, and the incoming acoustic wave at the unit cell can result from operation of cooling fans of the servers of the rack of servers.

One or more example aspects, such as corresponding to example operations of a method, can be represented in FIG. 12. Example operation 1202 represents obtaining, by a system comprising a controller, a frequency value representative of a frequency of an acoustic wave to cancel. Example operation 1204 represents controlling, by the system, a heater to adjust temperature of air within a Helmholtz resonator unit cell, based on the frequency of the acoustic wave, to resonate the Helmholtz resonator unit cell to cancel noise can included by the acoustic wave.

Controlling the heater can include obtaining sensed temperature data representative of sensed temperature of the air within the Helmholtz resonator unit cell, determining an estimated air temperature value based on the frequency of the acoustic wave, and applying a voltage bias to the heater to adjust the air temperature based on the estimated air temperature value.

Controlling the heater can include obtaining frequency data representative of the frequency of the acoustic wave, and applying a voltage bias to the heater to adjust the air temperature based on the frequency data.

Controlling the heater can include obtaining noise level data representative of the acoustic wave, and applying a voltage bias to the heater to adjust the air temperature based on the noise level data.

One or more aspects can be embodied in a metasurface, such as described and represented in the drawing figures herein. The metasurface can include a base structure, and a group of respective unit cells contained by the base structure. The respective unit cells can include respective Helmholtz resonators comprising respective air chambers coupled to respective neck ports that extend to a surface of the base structure to facilitate air flow to the respective air chambers, and respective heaters that are controllable to change respective air temperatures within the respective Helmholtz resonators. The respective air temperatures are adjustable, via the respective heaters, to resonate the respective unit cells at respective specific frequency values to collectively phase cancel an incoming acoustic wave responsive to being exposed to the incoming acoustic wave.

The respective unit cells can be evenly distributed in an array pattern within the base structure.

The respective unit cells can include respective neck ports and respective chambers, and the respective heaters can be within the respective chambers.

The metasurface can be configured to collectively phase cancel at least one incoming acoustic wave respectively emanating from at least one server.

As can be seen, the technology described herein facilitates construction and deployment of a metasurface of unit cells having variable air temperature properties controlled via heaters, which can be implemented in a practical, compact and lightweight surface configuration. As one example, the metasurface is highly useful in the context of mitigating server noise. One unit-cell design achieved high sound absorption of an incoming sound wave at the frequency for which it was designed and temperature-adjusted. Based on the technology described herein, thin, lightweight, and cost effective sound absorbers can be constructed, including by using 3D printing technology.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a unit cell of a metasurface configured for sound absorption within a narrowband frequency range, the unit cell comprising:
an air cavity within a support, the air cavity comprising a chamber and a neck port; and
a heater that heats air in the air cavity to determine a resonant frequency of the unit cell, to resonate the unit cell at the resonant frequency to phase cancel the incoming acoustic wave, responsive to being exposed to the incoming acoustic wave.

2. The system of claim 1, wherein the heater comprises a resistive heating element that increases in temperature based on a controlled amount of energy applied to the resistive heating element.

3. The system of claim 1, wherein the heater comprises at least one heating element positioned proximate to a floor of the chamber.

4. The system of claim 1, wherein the heater comprises at least one heating element positioned proximate to a side of the chamber.

5. The system of claim 1, wherein the heater comprises at least one heating element positioned proximate to a floor of the chamber, and at least one heating element positioned proximate to a side of the chamber.

6. The system of claim 1, wherein at least part of the heater is within the air cavity.

7. The system of claim 1, further comprising a sensor, and a controller coupled to the heater, wherein the controller selectively applies energy to the heater to heat the air in the air cavity based on data sensed by the sensor.

8. The system of claim 7, wherein the sensor comprises a temperature sensor that senses air temperature data of the air within the air cavity as at least part of the data sensed by the sensor.

9. The system of claim 7, wherein the sensor comprises a noise sensor that senses frequency data associated with a frequency of the incoming acoustic wave as at least part of the data sensed by the sensor.

10. The system of claim 1, wherein the unit cell is a first unit cell having first air in a first air cavity, and further comprising a second unit cell having second air in a second air cavity, wherein the heater comprises a shared heating device that heats the first air in the first air cavity, and the second air in the second air cavity.

11. The system of claim 1, wherein the unit cell is incorporated into a metasurface comprising an array of unit cells.

12. The system of claim 11, wherein the metasurface is positioned proximate a server, and wherein the incoming acoustic wave at the unit cell results from operation of a cooling fan of the server, or
wherein the metasurface is positioned proximate to a rack of servers, and wherein the incoming acoustic wave at the unit cell results from operation of cooling fans of the servers of the rack of servers.

13. A method, comprising:
obtaining, by a system comprising a controller, a frequency value representative of a frequency of an acoustic wave to cancel; and
controlling, by the system, a heater to adjust temperature of air within a Helmholtz resonator unit cell, based on the frequency of the acoustic wave, to resonate the Helmholtz resonator unit cell to cancel noise comprised by the acoustic wave.

14. The method of claim 13, wherein the controlling of the heater comprises obtaining sensed temperature data representative of sensed temperature of the air within the Helmholtz resonator unit cell, determining an estimated air temperature value based on the frequency of the acoustic wave, and applying a voltage bias to the heater to adjust the air temperature based on the estimated air temperature value.

15. The method of claim 13, wherein the controlling of the heater comprises obtaining frequency data representative of the frequency of the acoustic wave, and applying a voltage bias to the heater to adjust the air temperature based on the frequency data.

16. The method of claim 13, wherein the controlling of the heater comprises obtaining noise level data representative of the acoustic wave, and applying a voltage bias to the heater to adjust the air temperature based on the noise level data.

17. A metasurface, comprising:
a base structure; and
a group of respective unit cells contained by the base structure,
wherein the respective unit cells comprise respective Helmholtz resonators comprising respective air chambers coupled to respective neck ports that extend to a surface of the base structure to facilitate air flow to the respective air chambers, and respective heaters that are controllable to change respective air temperatures within the respective Helmholtz resonators, and
wherein the respective air temperatures are adjustable, via the respective heaters, to resonate the respective unit cells at respective specific frequency values to collectively phase cancel an incoming acoustic wave responsive to being exposed to the incoming acoustic wave.

18. The metasurface of claim 17, wherein the respective unit cells are evenly distributed in an array pattern within the base structure.

19. The metasurface of claim 17, wherein the respective unit cells comprise respective neck ports and respective chambers, and wherein the respective heaters are within the respective chambers.

20. The metasurface of claim 17, wherein the metasurface is configured to collectively phase cancel at least one incoming acoustic wave respectively emanating from at least one server.
